(19) United States
(12) Patent Application Publication
(10) Pub. No.: US 2005/0188404 A1
(43) Pub. Date: Aug. 25, 2005

(54) System and method for providing content list in response to selected content provider-defined word

(75) Inventor: Behram Mario Dacosta, San Diego, CA (US)

Correspondence Address: ROGITZ & ASSOCIATES;Suite 3120, 750 B Street, San Diego, CA, 92101, US

(73) Assignees: SONY CORPORATION, Tokyo (JP); SONY ELECTRONICS INC., Park Ridge, NJ (US)

(21) Appl. No.: 10/845,341

(22) Filed: May 13, 2004

Related U.S. Application Data
(63) Continuation-in-part of application No. 10/782,265, filed on Feb. 19, 2004.

(51) Int. Cl. H04N 7/173; G06F 13/00; H04N 5/445; G06F 3/00; G06F 17/30; G06F 7/00

(52) U.S. Cl. 725/52; 725/51; 725/39; 725/53

(57) ABSTRACT

A remote control device for a TV can be used to select a word in a closed caption text, and if the word is associated with additional content, a list of the content is displayed on the TV. The user can select a piece of content from the list. A dictionary meaning of a selected word may also or alternatively be provided. Alternatively, only a subset of closed captioning words need be shown to the viewer, or the presented words may be defined by the content provider independently of closed captioning text.

### RELATED APPLICATIONS

The present application is a Continuation-In-Part of U.S. patent application Ser. No. 10/782,265, filed on Feb. 19, 2004.

### Field of the Invention

The present invention relates generally to television systems.

### BACKGROUND

The present invention critically recognizes that it is often the case that a person watching a television program might observe something of particular interest to the person, who might consequently desire to learn more about it. For instance, a person might be watching a show about antiques, happen to see an antique from Venice, and form a desire to learn more about Venice. Currently, no further information directly related to Venice would be retrievable by the user using the TV system except possibly by scrolling through the remaining channels, hoping to catch, by mere chance, another show on Venice. Accordingly, further information retrieval on an item in a TV show requires off-line search at a library or Internet computer.

The present invention also recognizes that many TV systems present closed-captioning text, and that this text can be used to address the above-noted problem.

### SUMMARY OF THE INVENTION

A method for obtaining information based on a TV program includes displaying, with the program, at least one word selected from the group of words consisting of a subset of closed captioning words (with the subset not containing all words in closed captioning text associated with the TV program), and words established independently of closed captioning content. The method then includes permitting a user of a remote control device communicating with the TV to select at least one word to establish a selected word, and then displaying a list of content related to the selected word.

In a preferred implementation, the list is displayed in a picture-in-picture (PIP) window on the TV, but it could also be displayed on a display of the remote control device. If the selected word is not a primary word, a dictionary definition of the selected word may be displayed.

A user can select at least one content on the list and display the content. The content may be obtained from an audio/video/textual data storage associated with the TV, or it may be downloaded from at least one of: the Internet, and a transmitter head end, in response to the user selecting the content. Downloaded content may be added to a local data storage associated with the TV and correlated with other content related to the selected word, or to other words in the content. The user can be billed for downloading the content.

The words can scroll across the screen and the user can browse forward and backward through the words, or the words can be displayed in static list.

In another aspect, a system for obtaining information using a TV closed caption display includes a TV receiving content from a source. The content includes text selected from the group consisting of some, but not all, words in closed captioning text associated with a TV program, and words established by a content provider independently of closed captioning content. A remote control device is configured for wireless communication with the TV. A data structure that is accessible to a computer is associated with at least one of: the source, and the TV. The computer retrieves from the data structure a list of content related to at least one word appearing in the closed caption text and selected by a user manipulating the remote control device. One type of content may be the dictionary definition of the selected word. In the case where content is not being viewed, a word or words may be entered into the system via the remote control device or other peripheral device, with subsequent functionality being implemented as above as if a word had been selected from closed captioning.

In yet another aspect, a system for retrieving content related to a TV program including closed caption text includes means for displaying the TV program with words selected from the group consisting of (1) a predefined subset of closed caption text, and (2) text that is predefined by a content provider independently of words appearing in closed caption text. Means are provided for selecting at least one word. Means are also provided for presenting a list of content associated with the word in response to the means for selecting.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present TV system;

FIG. 2 is a flow chart of a first embodiment of the present logic;

FIG. 3 is a flow chart of a second embodiment of the present logic; and

FIG. 4 is a flow chart of a third embodiment of the present logic.

### DETAILED DESCRIPTION OF THE PREFERRED EMBODIMENT

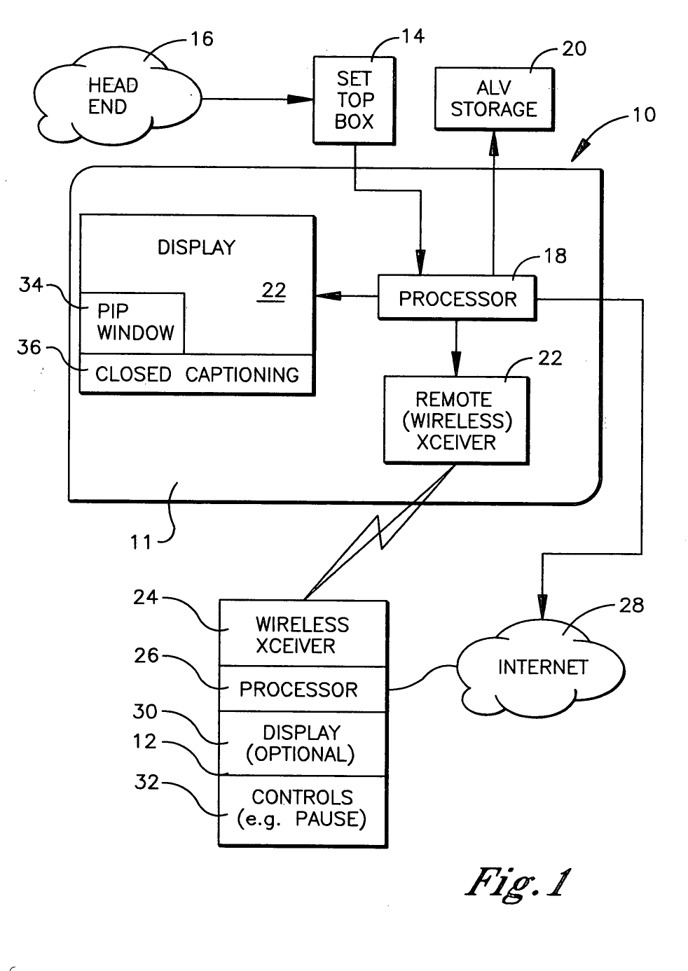

Referring initially to FIG. 1, a system is shown, generally designated 10, that includes a television 11 and a remote control device 12. The television 11 receives a signal from a cable/satellite/terrestrial content receiver 14, such as might be implemented from a set-top box communicating with a cable head end 16, or from a PVR or other device. Choice of the program provider is up to the discretion of the operator. The content receiver 14 then transmits signals to a personal video recorder (PVR) and/or directly to a processor 18 within the television 11. The personal video recorder is an optional element added at the operator's will in order to observe images other than those from the content receiver 14. Content may be stored in an audio-video storage 20 that can be part of, e.g., a PVR.

As shown in FIG. 1, the processor 18 drives a TV display 22 and also sends signals to and receives signals from a wireless Infrared (IR) or wireless radiofrequency (RF) transceiver 22. In turn, the transceiver 22 relays the signal to a complementary wireless transceiver 24 on the remote control device 12. The transceiver 24 sends the information to a processor 26 on the remote control device 12. Another option the operator has is to import an internet signal from an external source 28 into one or both of the processors 18, 26 via wired or wireless links. The wireless links may be optical wireless (e.g., IR) or rf wireless (e.g., IEEE 802.11) links.

As further shown in FIG. 1, the remote control device 12 includes an optional video display 30 and a control section 32 that can have buttons for controlling the TV 11, such as volume control, channel control, PVR control, etc. The display 30 may be a touch-screen display in which case the functions of the display 30 and control section 32 can be combined.

In accordance with present principles, the display 22 of the TV 11 can display a picture-in-picture window 34, in addition to the main screen display. Also, the display 22 can present closed captioning text in a CC window 36 in accordance with principles known in the art when the selected program contains CC information. As intended by one embodiment of the present invention, some words in the closed captioning appear differently than other words, for purposes to be shortly disclosed. By way of non-limiting example, in FIG. 1 the word “closed” is not underlined, whereas the word “captioning” is. Other means can be implemented for making some words appear differently than others, e.g., some words can be italicized, or bolded, or have a different font or font size or color, than other words. Or, the anomalous words can flash between on and off or between bright and low.

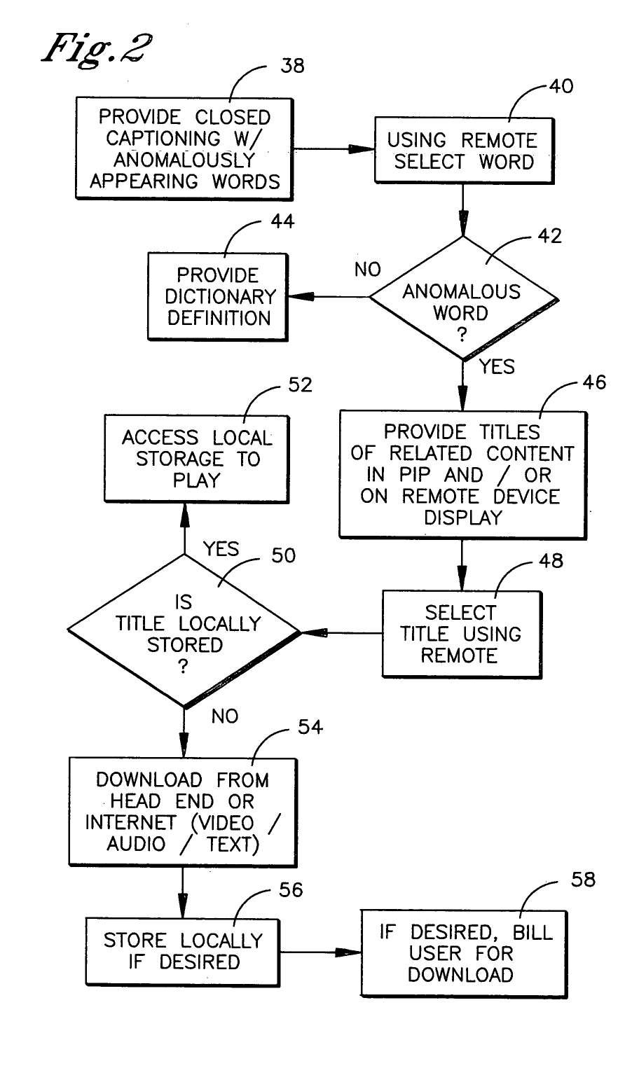

FIG. 2 shows the logic for permitting a user of the remote control device 12 to communicate with the TV 11 to select at least one word to establish a selected word and cause a list of content related to the selected word to be displayed in, e.g., the PIP window 34 or remote control display 30. Commencing at block 38, closed captioning programming is provided to the TV 11, with some words in the CC appearing anomalously (e.g., by being underlined or otherwise distinguished as set forth above). Moving to block 40, the user may manipulate the remote control device 12 to select a word.

At decision diamond 42 it is determined whether the selected word is an anomalously appearing word, and if not the process can end or, if desired, provide a dictionary definition of the word at block 44. The dictionary definition may be looked up from a database in, e.g., the storage 20 or Internet 28 or at the head end 16.

To determine whether the selected word is an anomalous word, the logic may look up a list of words in a data structure (database table, file system, etc.) in, e.g., the local storage 20 or on the Internet 28. This data structure can correlate anomalous words with the titles of programs or other content that are related to the word. The list can be updated by the operator of the cable head end, the programming source, etc. to coordinate the list with the presentation of anomalous words in the closed captioning.

If the selected word is an anomalously appearing word, the process moves to block 46 to provide a list of titles of audio/video or textual programming or other content that is related to the word. This list may be presented in the PIP window 34 or the remote control device display 30.

At block 48 the user can manipulate the remote control device 12 to select one of the titles for display, in which case the logic flows to decision diamond 50 to determine the location of the program. If it is stored locally in the storage 20, the storage is accessed at block 52 to retrieve the program for display on the TV 11. Otherwise, the program is downloaded at block 54 from the head end 16 or the Internet 28 for display on the TV 11 or for local storage. The program can include video, audio, and/or textual information related to the word selected at block 40. If desired, the program may be stored locally at block 56 and correlated to the selected word, and the user then billed at block 58 for the download.

As envisioned herein, content may not be actively being viewed, but a user can nonetheless enter a word into the system using the remote control device or other peripheral device, with subsequent functionality being implemented as above as if a word had been selected from closed captioning.

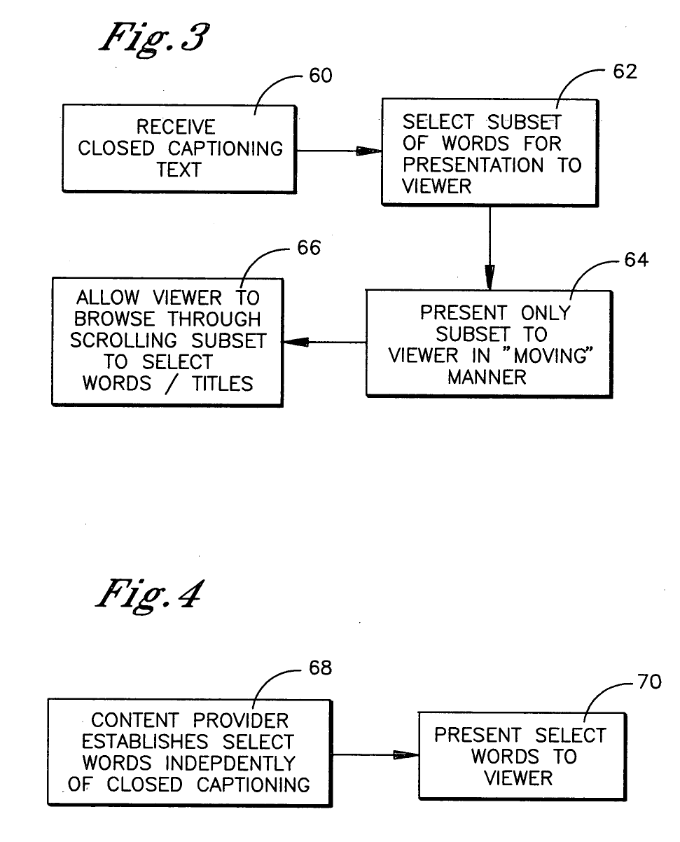

FIG. 3 shows that in an alternate embodiment, the entire closed captioning text might not be provided, but only a subset thereof, to avoid clutter and to ease the burden on a viewer in trying to identify a relevant word to select. Specifically, at block 60 an entity such as the content provider may receive closed captioning text and then select only a subset of words in the text at block 62. Preferably, only distinguishing words that bear particular relevance to the program or to a theme or topic thereof are selected. At block 64 only the subset of words is presented to the viewer, i.e., only the subset of words, which is less than the original closed captioning text, is presented on screen.

Like a complete closed captioning text display, the subset of words can scroll across the screen. Furthermore, at block 66 the processor of the TV, in response to “forward” and “back” signals which are generated by the viewer by appropriately manipulating buttons on the remote control device 12, can cause the words to move forward and back across the screen as desired by the user. In this way, the user can stop and reverse the scrolling text display to review previously displayed words, or the user can look ahead to words corresponding to content to be shortly presented. To facilitate this, portions or all of the subset of closed captioning words can be downloaded to the TV ahead of the actual content for storage and subsequent display.

In yet other embodiments, instead of scrolling selectable words across the display, some or all words that are predefined by a content provider to link to other content can be statically displayed together in a window on the TV.

In any case, the logic can proceed from block 66 to function in accordance with the logic set forth above to allow a user to select words and additional content.

FIG. 4 shows that instead of selectable words being derived from closed captioning text, at block 68 a content provider can establish a set of words independently of text in closed captioning. Of course, some of the words coincidentally might appear in closed captioning text. At block 70, the words are presented to the viewer to allow access to additional content in accordance with principles set forth above.

While the particular SYSTEM AND METHOD FOR PROVIDING CONTENT LIST IN RESPONSE TO SELECTED CONTENT PROVIDER-DEFINED WORD as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. For instance, “at least one word” means not only a single word, but also a phrase having multiple words. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

1. A method for obtaining information based on a TV program, comprising:
displaying, with the program, at least one word selected from the group of words consisting of: a subset of closed captioning words, the subset not containing all words in closed captioning text associated with the TV program, and words established independently of closed captioning content;
permitting a user of a remote control device communicating with the TV to select at least one word to establish a selected word; and
displaying a list of content related to the selected word.

2. The method of claim 1, wherein the list is displayed in at least one of: a picture-in-picture (PIP) window on the TV, and a display of the remote control device.

3. The method of claim 1, further comprising permitting a user to select at least one content on the list and displaying the content.

4. The method of claim 3, wherein the content is obtained from an audio/video data storage associated with the TV.

5. The method of claim 3, wherein the content is downloaded from at least one of: the Internet, and a transmitter head end, in response to the user selecting the content.

6. The method of claim 1, further comprising allowing a viewer to scroll forward and backward through displayed words.

7. The method of claim 1, wherein the words are statically displayed in a list.

8. A system for obtaining information using a TV display, comprising:
a TV receiving content from a source, the content including text selected from the group consisting of: some, but not all, words in closed captioning text associated with a TV program, and words established by a content provider independently of closed captioning content;
a remote control device configured for wireless communication with the TV; and
a data structure accessible to a computer associated with at least one of:
the source, and the TV, the computer retrieving from the data structure a list of content related to at least one word appearing on the display and selected by a user manipulating the remote control device.

9. The system of claim 8, wherein the list is displayed in a picture-in-picture (PIP) window on the TV.

10. The system of claim 8, wherein the list is displayed on a display of the remote control device.

11. The system of claim 8, wherein the remote control device can be manipulated to select at least one content on the list for displaying the content.

12. The system of claim 11, wherein the content is obtained from an audio/video data storage associated with the TV, and the computer is in the TV.

13. The system of claim 11, wherein the content is downloaded from at least one of: the Internet, and a transmitter head end, in response to the user selecting the content.

14. The system of claim 8, wherein a processor associated with the TV receives viewer-generated control signals and in response causes words to move forward and backward on the display as desired by the viewer.

15. The system of claim 8, wherein a processor associated with the TV statically displays the words in a window.

16. A system for retrieving content related to a TV program including closed caption text, comprising:
means for displaying the TV program with words selected from the group consisting of: a predefined subset of closed caption text, and text predefined by a content provider independently of words appearing in closed caption text;
means for selecting at least one word; and
means for presenting a list of content associated with the word in response to the means for selecting.

17. The system of claim 16, wherein the list is displayed in a picture-in-picture (PIP) window on a TV.

18. The system of claim 16, wherein the list is displayed on a display of a remote control device.

19. The system of claim 16, wherein the words scroll across the TV and a user can browse forward and backward through the words.

20. The system of claim 16, wherein the words do not move across the TV and a user can browse through the words.
